(19) United States
(12) Patent Application Publication
(10) Pub. No.: US 2015/0231793 A1
(43) Pub. Date: Aug. 20, 2015

(54) Cutting Strand Segment

(71) Applicant: Robert Bosch GmbH, Stuttgart (DE)

(72) Inventors: Uwe Engelfried, Ostfildern (DE); Petr Grulich, Kirchheim/Teck (DE)

(21) Appl. No.: 14/424,520

(22) PCT Filed: Jul. 22, 2013
(86) PCT No.: PCT/EP2013/065388

§ 371 Date: Feb. 27, 2015

(30) Foreign Application Priority Data
Aug. 31, 2012 (DE) 10 2012 215 460.4

(51) Int. Cl. B27B 33/14; B27B 17/02

(52) U.S. Cl. CPC B27B 33/141; B27B 33/142; B27B 17/02

(57) ABSTRACT

A cutting strand segment for a cutting strand of a machine tool separating device includes at least one blade carrier element, at least one blade element arranged on the blade carrier element, and at least one cutting depth limiting element arranged on the blade carrier element which is configured to limit a maximum cutting depth of the blade element to a value that is less than 0.5 mm.

### PRIOR ART

There are already known cutting strand segments for a cutting strand of a power-tool parting device, which comprise a cutter carrier element, a cutting element disposed on the cutter carrier element, and a cut-depth limiting element, disposed on the cutter carrier element, for limiting a maximum depth of cut of the cutting element.

### DISCLOSURE OF THE INVENTION

The invention is based on a cutting strand segment for a cutting strand of a power-tool parting device, comprising at least one a cutter carrier element, comprising a cutting element disposed on the cutter carrier element, and comprising at least one cut-depth limiting element, disposed on the cutter carrier element, for limiting a maximum depth of cut of the cutting element.

It is proposed that the cut-depth limiting element limit a maximum depth of cut of the cutting element to a value of less than 0.5 mm. A “cutting strand segment” is to be understood here to mean, in particular, a segment of a cutting strand provided to be connected to further segments of the cutting strand for the purpose of constituting the cutting strand. “Provided” is to be understood here to mean, in particular, specially designed and/or specially equipped. Preferably, the cutting strand segment is realized as a chain link, which is connected to further cutting strand segments, realized as chain links, for the purpose of constituting the cutting strand, preferably realized as a cutting chain. In particular, the cutting strand segment has a maximum weight that is less than 1 g, preferably less than 0.5 g, and particularly preferably less than 0.2 g. The cutting strand segment in this case can be realized as a driving member, as a connecting member, as a cutting member, etc. of a cutting chain. The cutting strand in this case can be realized as a cutting chain having one, two or three link plates. Preferably, for the purpose of forming the cutting strand, the cutter carrier element is coupled, in particular connected in a form-fitting manner, to a further cutter carrier element of a further cutting strand segment of the cutting strand. A “cutter carrier element” is to be understood here to mean, in particular, an element on which there is disposed at least one cutting element for parting off and/or removing material particles of a workpiece on which work is to be performed. The cutting element in this case can be realized as a semi-chisel tooth, as a full-chisel tooth, as a “scratcher” tooth, etc., or as a V-tooth, as a hump tooth, as a standard tooth, in particular as a standard tooth standard tooth realized to have the shape of an equilateral triangle, etc. It is also conceivable, however, for the cutting element to have a different tooth shape, considered appropriate by persons skilled in the art. Particularly preferably, the cutting element is realized so as to be other than a chipper tooth, semi-chisel tooth and full-chisel tooth. In particular, the cutting element is realized as a “scratcher” tooth. The cutting element in this case is preferably realized as a standard wood-cutting tooth or standard metal-cutting tooth. The cutting element in this case is fixed to the cutter carrier element by means of a form-fitting, force-fitting and/or adhesive connection. Particularly preferably, the cutting element is realized so as to be integral with the cutter carrier element. “Integral with” is to be understood to mean, in particular, connected at least by adhesive force, for example by a welding process, a bonding process, an injection process and/or another process considered appropriate by persons skilled in the art, and/or, advantageously, formed in one piece such as, for example, by being produced from a casting and/or by being produced in a single or multi-component injection process and, advantageously, from a single blank.

Particularly preferably, the cutting strand segment has a connecting element, disposed on the cutter carrier element, and has a connecting recess, disposed on the cutter carrier element, for receiving a connecting element disposed on the further cutter carrier element that can be connected to the cutter carrier element. Preferably, the connecting element is integrally formed on to the cutter carrier element. A distance between a central axis of the connecting element and the connecting recess, a so-called spacing of the cutting strand is, in particular, less than 6 mm, preferably less than 5 mm, and particularly preferably less than 4 mm. In an alternative design of the cutting strand segment according to the invention, the connecting element is realized as a component that is realized so as to be separate from the cutter carrier elements. The cutter carrier elements in this case preferably each have two connecting recesses, into each of which a connecting element can be inserted, wherein the connecting element, following insertion, is fixed to the cutter carrier element and the further cutter carrier element by means of a forming process such as, for example, a stamping process, or by means of an adhesive process. The term “connecting element” is intended here to define, in particular, an element provided to join together in a form-fitting and/or force-fitting manner, in particular to join together in a movable manner, at least two components, in order to transmit a driving force and/or a driving torque.

The term “cut-depth limiting element” is intended here to define, in particular, an element that, when work is being performed on a workpiece, in particular during removal of at least one workpiece chip, limits penetration of the cutting element into the workpiece to a maximum value and thereby defines a maximum chip thickness of a workpiece chip removed when work is being performed on a workpiece. The cut-depth limiting element, as viewed along a cutting direction of the cutting element, is preferably disposed after the cutting element, on the cutter carrier element. It is also conceivable, however, for the cut-depth limiting element to be disposed at a different position on the cutter carrier element, considered appropriate by persons skilled in the art, such as, for example, as viewed along the cutting direction of the cutting element, before and after the cutting element, next to the cutting element, etc. A “cutting direction” is to be understood here to mean, in particular, a direction along which the cutting element is moved, in at least one operating state, as a result of a driving force and/or a driving torque, in particular in a guide unit of the power-tool parting device, for the purpose of generating a cutting clearance and/or parting-off and/or removing material particles, in particular workpiece chips, of a workpiece on which work is to be performed. Advantageously, owing to the design of the cutting strand segment according to the invention, the cutting element is subjected only to a small amount of loading during removal of a workpiece chip when work is being performed on a workpiece. Moreover, advantageously, the cutting strand segment according to the invention makes it possible to achieve a cut with little tearing.

Advantageously, the cut-depth limiting element limits a maximum depth of cut of the cutting element to a value of less than 0.3 mm, in particular to a value of less than 0.25 mm. Thus, advantageously, when work is being performed on a workpiece, the cutting strand segment can run without jolting, in particular when the cutting strand segment has been connected to further cutting strand segments of the cutting strand.

Furthermore, it is proposed that the cutting strand segment have at least one transverse securing element, which is disposed on the cutter carrier element and which is provided to secure the cutter carrier element, when in a mounted state, insofar as possible against a transverse movement relative to a further cutter carrier element of the cutting strand. The transverse securing element is preferably formed on to the cutter carrier element by tensile forming. It is also conceivable, however, for the transverse securing region to be disposed on the cutter carrier element by means of another type of connection considered appropriate by persons skilled in the art, such as, for example, by means of a form-fit connection method (clip on by means of resilient hook regions, etc.), by means of a welding method, etc. Particularly preferably, the cutter carrier element has at least one stamped transverse securing element. A “transverse securing element” is to be understood here to mean, in particular, an element that, as a result of a form fit and/or as a result of a force fit, to secure a movement along a transverse axis that runs at least substantially perpendicularly in relation to a cutting plane of the cutting strand. The term “cutting plane” is intended here to define, in particular, a plane in which the cutting strand segment is moved for the purpose of performing work on a workpiece, in at least one operating state. Preferably, when work is being performed on a workpiece, the cutting plane is aligned at least substantially transversely in relation to a workpiece surface on which work is to be performed.

“At least substantially transversely” is to be understood here to mean, in particular, an alignment of a plane and/or a direction, relative to a further plane and/or a further direction, that is preferably other than a parallel alignment of the plane and/or the direction relative to the further plane and/or the further direction. It is also conceivable, however, for the cutting plane, during working of a workpiece, to be aligned at least substantially parallelwise in relation to a workpiece surface to be worked, in particular if the cutting element is realized as an abrasive means, etc. “At least substantially parallelwise” is intended here to mean, in particular, an alignment of a direction relative to a reference direction, in particular in one plane, the direction deviating from the reference direction by, in particular, less than 8°, advantageously less than 5°, and particularly advantageously less than 2°. Preferably, the transverse securing element is realized so as to differ from a rivet head or a screw head. Preferably, the transverse securing element is provided to secure, or delimit, a transverse movement, by means of a form fit. It is also conceivable, however, for the transverse securing element to at least secure, or limit, a transverse movement in a different manner, considered appropriate by persons skilled in the art, such as, for example, by means of a magnetic force. The expression “when the cutter carrier element is in a mounted state, to secure insofar as possible against a transverse movement relative to a further cutter carrier element of the cutting strand” is intended here to define, in particular, a limitation of a movement of the cutter carrier elements, connected to each other by means of at least one connecting element, relative to each other, by means of the transverse securing element, along a movement distance that is at least substantially perpendicular to a cutting plane of the cutting strand. The movement distance of the cutter carrier elements relative to each other in this case is limited, in particular by means of the transverse securing element, to a value of less than 5 mm, preferably less than 2 mm, and particularly preferably less than 1 mm. Advantageously, the design according to the invention makes it possible to prevent, at least to a very large extent, a lateral displacement of the cutter carrier element relative to the further cutter carrier element during operation, in particular during the making of a cut, etc. Thus, advantageously, a precise work result can be achieved.

Preferably, the transverse securing element is disposed on the connecting element. Particularly preferably in this case, after the cutter carrier element has been coupled to the further cutter carrier element, the transverse securing element is formed on to the connecting element by a forming process. Preferably, following coupling and following forming-on of the transverse securing element, the cutter carrier element and the further cutter carrier element have at least one clearance fit. Preferably, a rotatable mounting is realized by means of the clearance fit and by means of a combined action of the connecting element of the cutter carrier element and a connecting recess of the further cutter carrier element. Advantageously, by means of the design according to the invention, the cutter carrier element can be reliably secured against displacement relative to the further cutter carrier element while work is being performed on a workpiece by means of the power-tool parting device according to the invention.

Advantageously, the connecting element is realized in the form of a stud. In this case, the connecting element has a circular cross section, as viewed in a plane that is at least substantially parallel to the cutting plane. Particularly preferably, the connecting element is realized in the form of a cylinder. It is also conceivable, however, for the connecting element to be of another design, considered appropriate by persons skilled in the art. A connecting element can be achieved by simple design means. Particularly preferably, after at least the cutter carrier element has been coupled to the further cutter carrier element of the cutting strand, the transverse securing element is stamped on to the connecting element of the cutting strand by means of a stamping device. Advantageously, the cutter carrier element can be secured to the further cutter carrier element in a reliable manner.

It is additionally proposed that the transverse securing element have at least one securing region that is at least substantially parallel to the cutting plane of the cutting element. Preferably, the securing region is in the shape of a circular ring, or circle. It is also conceivable, however, for the securing region be of a different shape, considered appropriate by persons skilled in the art, such as, for example, shaped as a sector of a circular ring, or as a partial extension, etc. Particularly preferably, the securing region is formed directly on to the connecting element as the result of a forming process, after the cutter carrier element and the further cutter carrier element have been mounted. By means of the design according to the invention, securing of the cutter carrier element can be realized in a structurally simple manner. Moreover, advantageously, it is advantageously possible to prevent the cutter carrier element and the further cutter carrier element from being unintentionally demounted after the transverse securing element securing region has formed on.

Furthermore, it is proposed that the cutting strand segment have a maximum volume that is less than 20 mm³. Preferably, the cutting strand segment has a maximum volume that is less than 10 mm³, and particularly preferably less than 5 mm³. Advantageously, the cutting strand segment can be produced inexpensively, with only a small amount of material being required.

Advantageously, the cutting strand segment, as viewed along a direction that is at least substantially perpendicular to a cutting plane of the cutting element, has a maximum dimension that is less than 4 mm. Preferably, the cutting strand segment, as viewed along a direction that is at least substantially perpendicular to a cutting plane of the cutting element, has a maximum dimension that is less than 3 mm, and particularly preferably less than 2.5 mm. Advantageously, a very compact cutting strand segment can be achieved, which can be used to make a narrow cut.

The invention is additionally based on a method for producing at least one cutting strand segment according to the invention. In this case, in a first step of the method, the cutting strand segment is preferably punched out of a strip stock by means of a punching device. In this case, for example, the connecting element and further functional regions of the cutting strand segment may be formed on to the cutting strand segment by means of a combined action of a lower die and an upper die during the punching process. It is also conceivable, however, for the cutting strand segment to be produced by means of a metal injection molding method (MIM method), or by means of another method, considered appropriate by persons skilled in the art. The method according to the invention makes it possible, advantageously, to achieve cost-effective production.

Furthermore, the invention is based on a cutting strand for a power-tool parting device, having at least one cutting strand segment according to the invention. A “cutting strand” is to be understood here to mean, in particular, a unit provided to locally undo an atomic coherence of a workpiece on which work is to be performed, in particular by means of a mechanical parting-off and/or by means of a mechanical removal of material particles of the workpiece. Preferably, the cutting strand is provided to separate the workpiece into at least two parts that are physically separate from each other, and/or to part off and/or remove, at least partially, material particles of the workpiece, starting from a surface of the workpiece. Particularly preferably, in at least one operating state, the cutting strand is moved in a revolving manner, in particular along a circumferential direction of a guide unit of the power-tool parting device. The cutting strand is preferably formed by connection of a plurality of cutting strand segments. The cutting strand is thus preferably realized as a cutting chain. The cutting strand segments in this case can be connected to each other in a separable manner, such as, for example, by means of a chain connecting link, etc., and/or in an inseparable manner. It is also conceivable, however, for the cutting strand to be realized as a cutting band and/or cutting cord. If the cutting strand is realized as a cutting band and/or cutting cord, the cutting strand segments are fixed directly to the cutting band and/or cutting cord. The cutting strand segments in this case can be spaced apart from each other and/or disposed in direct contact with each other on the cutting band and/or cutting cord. The design according to the invention makes it possible, advantageously, to realize a cutting strand that, in operation, runs at least substantially without jolting. Moreover, advantageously, the cut-depth limiting elements of the individual cutting strand segments minimize any risk of breakage of the chain caused by overloading resulting from the cutting elements penetrating deeply into a workpiece on which work is to be performed.

The invention is additionally based on a power-tool parting device, in particular a hand-held power-tool parting device, having a cutting strand according to the invention. Preferably, the power-tool parting device comprises a guide unit for guiding the cutting strand, the guide unit and the cutting strand together constituting a closed system. A “guide unit” is to be understood here to mean, in particular, a unit provided to exert a constraining force upon the cutting strand, at least along a direction perpendicular to a cutting direction of the cutting strand, in order to define a possibility for movement of the cutting strand along the cutting direction. Preferably, the guide unit has at least one guide element, in particular a guide groove, by which the cutting strand is guided. Preferably, the cutting strand, as viewed in a cutting plane, is guided by the guide unit along an entire circumference of the guide unit, by means of the guide element, in particular the guide groove. The term “closed system” is intended here to define, in particular, a system comprising at least two components that, by means of combined action, when the system has been demounted from a system such as, for example, a power tool, that is of a higher order than the system, maintain a functionality and/or are inseparably connected to each other when in the demounted state. Preferably, the at least two components of the closed system are connected to each other so as to be at least substantially inseparable by an operator. “At least substantially inseparable” is to be understood here to mean, in particular, a connection of at least two components that can be separated from each other only with the aid of parting tools such as, for example, a saw, in particular a mechanical saw, etc. and/or chemical parting means such as, for example, solvents, etc. Advantageously, an insert tool can be realized that can be used in an effective manner, being suitable for a broad spectrum of working on workpieces.

Furthermore, it is proposed that the power-tool parting device comprise at least the guide unit, wherein the cutting strand segment has at least one segment guide element, which is disposed on the cutter carrier element and which is provided to limit a movement of the cutting strand segment, when the cutting strand is disposed on the guide unit, as viewed in a direction away from the guide unit, at least along a direction that is at least substantially parallel to a cutting plane of the cutting element. Particularly preferably, each cutting strand segment of the cutting strand of the power-tool parting device has at least one segment guide element, which is provided to limit a movement of the respective cutting-strand element, when disposed in a guide unit, as viewed in a direction away from the guide unit, at least along a direction that is at least substantially parallel to a cutting plane of the cutting strand. Preferably, the guide unit has at least one segment counter-guide element that corresponds to the segment guide element. Preferably, the guide unit has at least one guide element, in particular a guide groove, by which the cutting strand is guided. Preferably, the cutting strand, as viewed in the cutting plane, is guided by the guide unit along an entire circumference of the guide unit by the guide unit by means of the guide element, in particular the guide groove. It is thereby possible, through simple design means, to achieve guidance along a direction of the cutting strand that extends at least substantially parallelwise in relation to a cutting plane of the cutting strand.

Furthermore, the invention is based on a power tool having at least one coupling device for coupling in a form-fitting and/or force-fitting manner to a power-tool parting device according to the invention. The power tool is preferably realized as a portable power tool. A “portable power tool” is to be understood here to mean in particular a power tool, in particular a hand-held power tool, that can be transported by an operator without the use of a transport machine. The portable power tool has, in particular, a mass of less than 40 kg, preferably less than 10 kg, and particularly preferably less than 5 kg. Preferably, the power tool and die power-tool parting device together constitute a power-tool system. Advantageously, by means of the design of the power tool according to the invention, it is possible to achieve a portable power tool that, particularly advantageously, is suitable for a broad spectrum of applications.

The cutting strand segment according to the invention, the cutting strand according to the invention, the power-tool parting device according to the invention and/or the portable power tool according to the invention are/is not intended in this case to be limited to the application and embodiment described above. In particular, the cutting strand segment according to the invention, the cutting strand according to the invention, the power-tool parting device according to the invention and/or the portable power tool according to the invention may have individual elements, components and units that differ in number from a number stated herein, in order to fulfill a principle of function described herein.

### DRAWING

Further advantages are given by the following description of the drawing. The drawing shows exemplary embodiments of the invention. The drawing, the description and the claims contain numerous features in combination. Persons skilled in the art will also expediently consider the features individually and combine them to create appropriate further combinations.

In the drawing:

FIG. 1 shows a portable power tool according to the invention, having a power-tool parting device according to the invention, in a schematic representation,

FIG. 2 shows a detail view of the power-tool parting device according to the invention, in a schematic representation,

FIG. 3 shows a detail view of a cutting strand segment according to the invention of a cutting strand according to the invention, in a schematic representation,

FIG. 4 shows a detail view of an alternative cutting strand segment according to the invention, in a schematic representation,

FIG. 5 shows a detail view of a further, alternative cutting strand segment according to the invention, in a schematic representation,

FIG. 6 shows a detail view of a further, alternative cutting strand segment according to the invention, in a schematic representation, and

FIG. 7 shows a detail view of an alternative cutting strand according to the invention, in a schematic representation.

### DESCRIPTION OF THE EXEMPLARY EMBODIMENTS

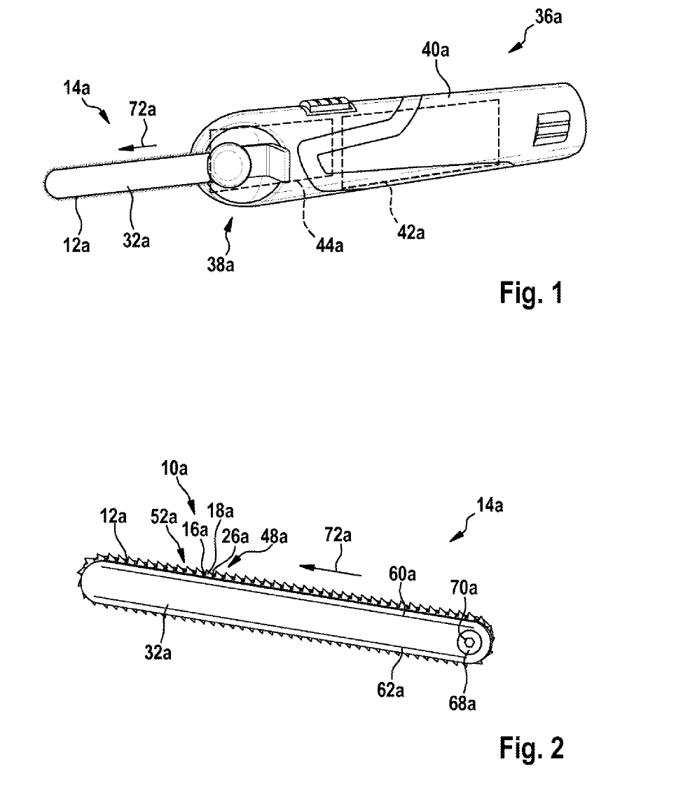

FIG. 1 shows a portable power tool 36a, having a power-tool parting device 14a, which together constitute a power-tool system. The portable power tool 36a has a coupling device 38a for coupling in a form-fitting and/or force-fitting manner to the power-tool parting device 14a. The coupling device 38a in this case can be realized as a bayonet closure and/or as another coupling device, considered appropriate by persons skilled in the art. The portable power tool 36a additionally has a power-tool housing 40a, which encloses a drive unit 42a and a transmission unit 44a of the portable power tool 36a. The drive unit 42a and the transmission unit 44a are connected to each other, in a manner already known to persons skilled in the art, to generate a drive torque that can be transmitted to the power-tool parting device 14a. The transmission unit 44a is realized as a bevel gear transmission. The drive unit 42a is realized as an electric motor unit. It is also conceivable, however, for the drive unit 42a and/or the transmission unit 44a to be of a different design, considered appropriate by persons skilled in the art. The drive unit 42a is provided to drive a cutting strand 12a of the power-tool parting device 14a at a cutting speed of less than 6 m/s, when in at least one operating state. The portable power tool 36a in this case has at least one operating mode, in which it is possible for the cutting strand 12a to be driven at a cutting speed of less than 6 m/s, in a guide unit 32a of the power-tool parting device 14, along a cutting direction 72a of a cutting element 18a of a cutting strand segment 10a.

FIG. 2 shows the power-tool parting device 14a decoupled from the coupling device 38a of the portable power tool 36a. The power-tool parting device 14a has the cutting strand 12a, which comprises at least one cutting strand segment 10a. In addition, the power-tool parting device 14a has the guide unit 32a, which, together with the cutting strand 12a, constitutes a closed system. The cutting strand 12a is guided by means of the guide unit 32a. For this purpose, the guide unit 32a has at least one guide groove (not represented in greater detail here). The cutting strand 12a is guided by means of edge regions of the guide unit 32a that delimit the guide groove. It is also conceivable, however, for the guide unit 32a to have a different element for guiding the cutting strand 12a, considered appropriate by persons skilled in the art, such as, for example, as a rib-type means, formed on the guide unit 32a, that engages in a recess on the cutting strand 12a. During operation, the cutting strand 12a is moved in a revolving manner along the circumference of the guide unit 32a, in the guide groove.

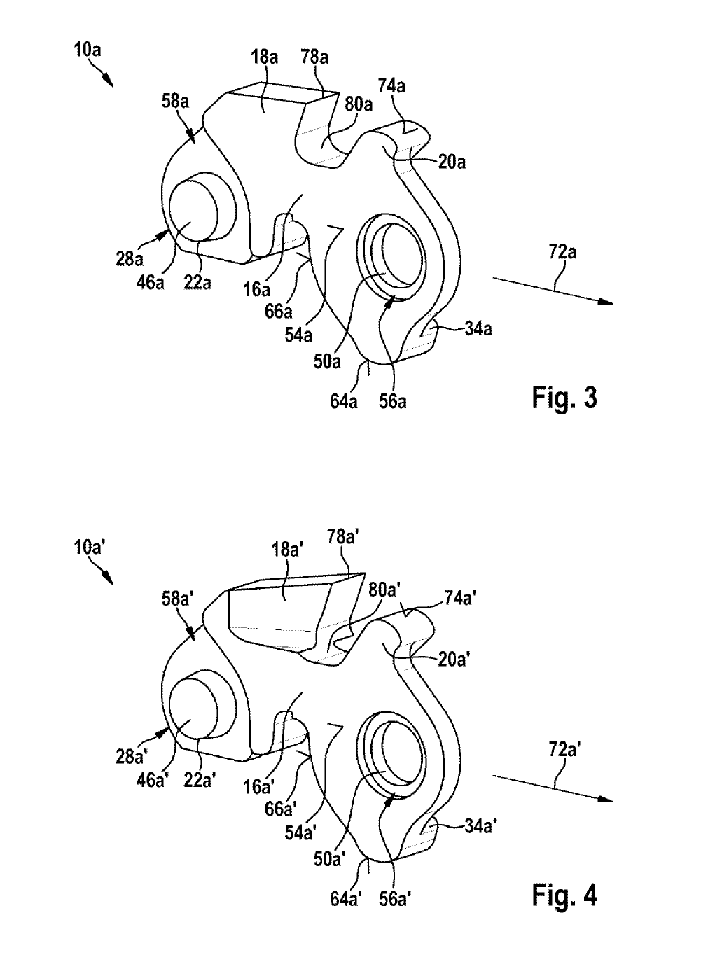

The cutting strand segment 10a has at least one connecting element 46a, which is realized so as to be integral with a cutter carrier element 16a of the cutting strand segment 10a (FIG. 3), for connection to a further cutting strand segment 48a of the cutting strand 12a. The cutting strand 12a thus comprises at least one connecting element 46a for connecting the cutting strand segment 10a and the further cutting strand segment 48a. The connecting element 46a is realized in the form of a stud. The connecting element 46a in this case is provided, by acting in combination with a connecting recess (not represented in greater detail here) of a further cutter carrier element 26a of the further cutting strand segment 48a, to realize a form-fitting connection between the cutter carrier element 16a and the further cutter carrier element 26a, or between the cutting strand segment 10a and the further cutting strand segment 48a. The cutting strand segment 10a likewise comprises a connecting recess 50a, disposed on the cutter carrier element 16a. The connecting recess 50a of the cutter carrier element 16a acts in combination with a further connecting element (not represented in greater detail here) of the cutting strand 12a, or of a third cutting strand segment 52a, to form the cutting strand 12a. Each cutting strand segment of the cutting strand 12a thus comprises at least one connecting element, disposed on the respective cutter carrier element of the cutting strand segments, and at least one connecting recess, disposed on the respective cutter carrier element of the cutting strand segments. Thus, by means of a combined action of the connecting elements and the connecting recesses, the cutting strand segments of the cutting strand 12a are mounted so as to be pivotable relative to each other.

The connecting element 46a of the cutting strand segment 10a closes in an at least substantially flush manner with at least one outer face 54a of the cutter carrier element 16a. It is also conceivable, however, for the connecting element 46a to project beyond the outer face 54a, as viewed along a direction at least substantially perpendicular to the outer face 54a, or to be set back relative to the outer face 54a. By projecting, or by closing in a flush manner with the outer face 54a of the connecting element 46a, the cutting strand segment 10a, when disposed in the guide groove, can be guided by means of the connecting element 46a at edge regions of the guide groove.

In addition, the cutting strand segment 10a has at least one transverse securing element 22a, which is disposed on the cutter carrier element 16a and which is provided to secure insofar as possible the cutter carrier element 16a, when in a mounted state, against a transverse movement relative to the further cutter carrier element 26a of the cutting strand 12a (FIG. 3). The cutting strand segment 10a has at least one stamped transverse securing element 22a. The transverse securing element 22a is disposed on the connecting element 46a. The transverse securing element 22a in this case has at least one securing region 28a, which is at least substantially parallel to a cutting plane of the cutting element 18a. The securing region 28a is thus at least substantially parallel to the outer face 54a of the cutter carrier element 16a. The transverse securing element 22a is stamped on to the connecting element 46a of the cutting strand 12a by means of a stamping device, after at least the cutter carrier element 16a has been coupled to the further cutter carrier element 26a of the cutting strand 12a. The securing region 28a is thus realized as a result of the stamping of the transverse securing element 22a.

The securing region 28a is provided, by acting in combination with a counter-securing region (not represented in greater detail here), in the form of a groove having the shape of a circular ring, of the further cutter carrier element 26a, to secure insofar as possible the cutter carrier element 16a, when in a mounted state, in at least one direction that is at least substantially perpendicular to the outer face 54a, against a transverse movement relative to the further cutter carrier element 26a of the cutting strand 12a. The cutting strand segment 10a likewise has a counter-securing region 56a in the form of a groove having the shape of a circular ring. The counter-securing region 56a is disposed in the region of the connecting recess 50a, on the cutter carrier element 16a. Furthermore, following connection of the connecting element 46a of the cutter carrier element 16a and a connecting recess of the further cutter carrier element 26a, the cutter carrier element 16a is secured insofar as possible, in at least one further direction that is at least substantially perpendicular to the outer face 54a, against a transverse movement relative to the further cutter carrier element 26a, by means of a combined action of an edge region of the further cutter carrier element 26a, that delimits the connecting recess of the further cutter carrier element 26a, with a coupling region 58a of the cutter carrier element 16a that surrounds the connecting element 46a of the further cutter carrier element 26a. In this case, each cutter carrier element of the cutting strand segments of the cutting strand 12a comprises at least one transverse securing element, which is disposed on the connecting element by means of stamping, after coupling to the further cutter carrier element.

Furthermore, the cutting strand segment 10a has at least one segment guide element 34a, which is disposed on the cutter carrier element 16a and which is provided to limit a movement of the cutting strand segment 10a, when disposed on the guide unit 32a, as viewed in a direction away from the guide unit 32a, at least along a direction that is at least substantially parallel to the cutting plane of the cutting element 18a (FIG. 3). The segment guide element 34a is constituted by a transverse extension, which extends at least substantially perpendicularly in relation to the outer face 54a of the cutter carrier element 16a. The segment guide element 34a in this case delimits a longitudinal groove. The segment guide element 34a is provided to act in combination with segment counter guide elements 60a, 62a of the guide unit 26 that are disposed on an inner face of the guide unit 32a that faces toward the cutter carrier element 16a, for the purpose of limiting movement (FIG. 2). The segment counter guide elements 60a, 62a are realized so as to correspond with the segment guide element 34a of the cutting strand segment 10a. In this case, each of the cutting strand segments of the cutting strand 12a comprises at least one segment guide element, which is provided to limit a movement of the cutting strand segments, when disposed in the guide unit 32a, as viewed in a direction away from the guide unit 32a, at least along a direction that is at least substantially parallel to the cutting plane of the cutting element 18a.

Moreover, the cutting strand segment 10a has a compressive-force transfer face 64a, disposed on the cutter carrier element 16a (FIG. 3). The compressive-force transfer face 64a is provided, by acting in combination with a compressive-force absorption region (not represented in greater detail here) of the guide unit 32a, to support compressive forces that act upon the cutting strand 12a as work is being performed on a workpiece (not represented in greater detail here). In this case, the compressive-force absorption region of the guide unit 32a, as viewed along a direction that is at least substantially perpendicular to the cutting plane of the cutting element 18a, is disposed between two outer faces of the guide unit 32a that are at least substantially parallel to each other. In this case, each of the cutting strand segments of the cutting strand 12a comprises a compressive-force transfer face.

The cutting strand segment 10a additionally has a driving face 66a, which is disposed on the cutter carrier element 16a and which is provided to act in combination with driving faces of a torque transmission element 68a (FIG. 2) of the power-tool parting device 14a, for the purpose of driving the cutting strand 12a. The driving faces of the torque transmission element 68a in this case are realized as tooth flanks. In this case, the driving face 66a of the cutter carrier element 14 is realized so as to correspond with the driving faces of the torque transmission element 68a. When the cutting strand 12a is being driven, the tooth flanks of the torque transmission element 68a bear temporarily against the driving face 66a, for the purpose of transmitting driving forces. In this case, each cutting strand segment of the cutting strand 12a thus comprises a driving face.

For the purpose of driving the cutting strand 12a, the torque transmission element 68a is rotatably mounted in the guide unit 32a. For the purpose of driving the cutting strand 12a, the torque transmission element 68a, when in a mounted state, is coupled to a pinion (not represented in greater detail here) of the drive unit 42a and/or to a gear wheel (not represented in greater detail here) and/or to a toothed shaft (not represented in greater detail here) of the transmission unit 44a. The torque transmission element 68a in this case has a coupling recess 70a that, when in a mounted state, can be coupled to a driving element of the portable power tool 36a. The coupling recess 70a is disposed concentrically in the torque transmission element 68a. In addition, the coupling recess 70a is provided to be coupled to the pinion (not represented in greater detail here) of the drive unit 42a and/or to a gear wheel (not represented in greater detail here) and/or to a toothed shaft (not represented in greater detail here) of the transmission unit 44a, when the torque transmission element 68a and/or the power-tool parting device 14a are/is in a coupled state. The coupling recess 70a is realized as a hexagon socket. It is also conceivable, however, for the coupling recess 70a to be of a different design, considered appropriate by persons skilled in the art. Moreover, it is conceivable for the power-tool parting device 14a, in an alternative design, not represented in greater detail here, to be realized so as to act in isolation from the torque transmission element 68a. In this case, the pinion (not represented in greater detail here) of the drive unit 42a and/or the gear wheel (not represented in greater detail here) and/or the toothed shaft (not represented in greater detail here) of the transmission unit 44a would engage directly in the guide unit 32a, and would act in isolation from interposition of a torque transmission element, disposed in the guide unit 32a, for the purpose of driving the cutting strand 12a.

In addition, the cutting strand segment 10a has at least one cutting element 18a, disposed on the cutter carrier element 16a. The cutting element 18a is realized so as to be integral with the cutter carrier element 16a. The cutting element 18a is provided to enable a workpiece (not represented in greater detail here) on which work is to be performed to be parted off, and/or to enable material particles to be removed therefrom. For this purpose, the cutting element 18a is realized as a “scratcher” tooth. The cutting element 18a in this case is at least substantially parallel to the outer face 54a of the cutter carrier element 16a. The cutting strand segment 10a in this case is integrally punched out of a strip stock, in one working step, by means of a punching device. Each cutting strand segment of the cutting strand 12a comprises at least one cutting element. It is also conceivable, however, for each of the cutting strand segments of the cutting strand 12a to have a different number of cutting elements. The cutting element 18a in this case may have a cutting layer (not represented in greater detail here) that comprises at least titanium carbide. The cutting layer is applied to the cutting element 18a by means of a CVD process. It is also conceivable, however, for the cutting layer to comprise, alternatively or additionally, another material such as, for example, titanium nitride, titanium carbonitride, aluminum oxide, titanium aluminum nitride, chromium nitride or zirconium carbonitride. Moreover, it is also conceivable for the cutting layer to be applied by means of another process, considered appropriate by persons skilled in the art, such as, for example, by means of a PVD or PACVD process. Furthermore, it is conceivable for the cutting element 18a to be provided with particles. In this case, the cutting element 18a may be provided with diamond particles, hard metal particles, or other particles considered appropriate by persons skilled in the art.

Furthermore, the cutting strand segment 10a comprises at least one cut-depth limiting element 20a, disposed on the cutter carrier element 16a, for limiting a maximum depth of cut of the cutting element 18a (FIG. 3). Thus, the cutting strand segment 10a comprises at least the cutter carrier element 16a, at least the cutting element 18a disposed on the cutter carrier element 16a, and at least the cut-depth limiting element 20a disposed on the cutter carrier element 16a, for limiting a maximum depth of cut of the cutting element 18a. The cutting strand segment 10a in this case has a maximum volume that is less than 20 mm³. The cut-depth limiting element 20a limits a maximum depth of cut of the cutting element 18a to a value of less than 0.5 mm. In this case, the cut-depth limiting element 20a limits a maximum depth of cut of the cutting element 18a to a value of less than 0.3 mm. The maximum depth of cut of the cutting element 18a is determined by a distance between a top side 74a of the cut-depth limiting element 20a and a cutting edge 78a of the cutting element 18a, as viewed along a direction that, in the cutting plane of the cutting element 18a, is at least substantially perpendicular to the cutting direction 72a of the cutting element 18a. The cut-depth limiting element 20a, as viewed along the cutting direction 72a of the cutting element 18a, is disposed behind the cutting element 18a, on the cutter carrier element 16a. A chip space 80a of the cutting strand segment 10a is thus formed, as viewed along the cutting direction 72a of the cutting element 18a. The cut-depth limiting element 20a in this case is realized so as to be integral with the cutter carrier element 16a. The cut-depth limiting element 20a is formed on to the cutter carrier element 16a, in the region of the connecting recess 50a. The cutting strand segments of the cutting strand 12a all have a respective cut-depth limiting element. It is also conceivable, however, that not every cutting strand segment of the cutting strand 12a has a cut-depth limiting element, and for the cutting strand segments to be combined with each other in various arrangements, with and without a cut-depth limiting element, to form the cutting strand 12a.

Alternative exemplary embodiments are represented in FIGS. 4 to 7. Components, features and functions that remain substantially the same are denoted, in principle, by the same references. To differentiate the exemplary embodiments, the letters a to c and/or apostrophes have been appended to the references of the exemplary embodiments. The description that follows is limited substantially to the differences in relation to the first exemplary embodiment described in FIGS. 1 to 3, and reference may be made to the description of the first exemplary embodiment in FIGS. 1 to 3 in respect of components, features and functions that remain the same.

FIG. 4 shows a cutting strand segment 10a′ as an alternative realization of the cutting strand segment 10a from FIG. 3. The cutting strand segment 10a′ is of a design that is at least substantially similar to that of the cutting strand segment 10a from FIG. 3. The difference between the cutting strand segment 10a from FIG. 3 and the cutting strand segment 10a′ consists in a design of the cutting element 18a of the cutting strand segment 10a from FIG. 3 and that of the cutting element 18a′ of the cutting strand segment 10a′ from FIG. 4. The cutting element 18a′ of the cutting strand segment 10a from FIG. 4 has, along a cutting direction 72a′ of the cutting element 18a′, a varying offset, relative to an outer face 54a′ of a cutter carrier element 16a′ of the cutting strand segment 10a′. In this case, the cutting element 18a′ is disposed on the cutter carrier element 16a′, inclined relative to the cutter carrier element 16a′, about two axes running at least substantially perpendicularly, relative to the outer face 54a′. The two at least substantially perpendicular axes in this case are preferably at least substantially parallel to the outer face 54a′ of the cutter carrier element 16a′ and/or to the cutting plane of the cutting element 18a′. In respect of further features of the cutting strand segment 10a from FIG. 4, reference may be made to the description of FIGS. 1 to 3. For the purpose of forming the cutting strand 12a from FIGS. 1 to 3, a plurality of cutting strand segments 10a′ from FIG. 4 and a plurality of cutting strand segments 10a from FIG. 3 may be disposed in a sequence considered appropriate by persons skilled in the art.

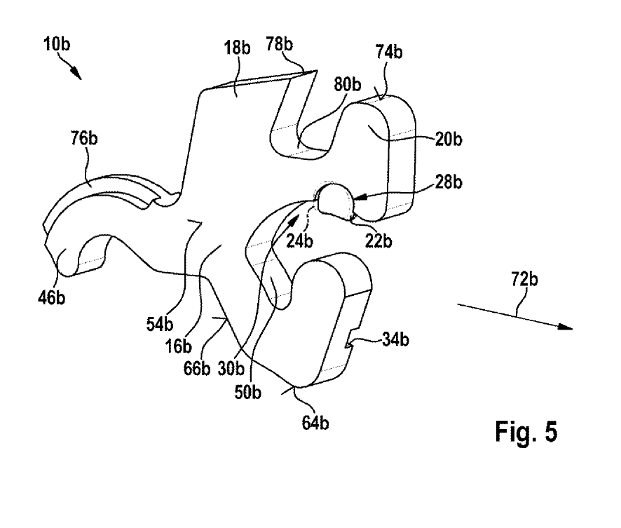

FIG. 5 shows a cutting strand segment 10b as an alternative realization of the cutting strand segment 10a from FIG. 3. The cutting strand segment 10b comprises at least one cutter carrier element 16b, at least one cutting element 18b disposed on the cutter carrier element 16b, and at least one cut-depth limiting element 20b disposed on the cutter carrier element 16b, for limiting a maximum depth of cut of the cutting element 18b. The cutting element 18b is realized as a “scratcher” tooth. In this case, the cutting element 18b is at least substantially parallel to an outer face 54b of the cutter carrier element 16b. The cutting strand segment 10b additionally comprises at least one connecting element 46b, disposed on the cutter carrier element 16b. The connecting element 46b is realized so as to be integral with the cutter carrier element 16b. The connecting element 46b in this case is realized as an elongate extension of the cutter carrier element 16b. The elongate extension is realized in the shape of a hook. The elongate extension in this case is realized so as to be other than a rod-shaped extension, on which there is a formed-on circular form-fitting element, and/or other than a semicircular extension.

Furthermore, the connecting element 46b, realized as an elongate extension, has a transverse securing region 76b on one side. The transverse securing region 76b is provided, by acting in combination with at least one transverse securing element of a further cutter carrier element (not represented in greater detail here) connected to the cutter carrier element 16b, to prevent, at least to a very large extent, a transverse movement of the cutter carrier element 16b along at least two opposing directions, when in a coupled state, relative to the further cutter carrier element. In this case, the transverse securing region 76b is realized as a rib. It is also conceivable, however, for the transverse securing region 76b to be of another design, considered appropriate by persons skilled in the art, such as, for example, designed as a groove, etc. The transverse securing region 76b is disposed on a side of the connecting element 46b that faces toward the cutting element 18b that is realized so as to be integral with the cutter carrier element 16b. Moreover, the transverse securing region 76b, or the connecting element 46b, as viewed along a cutting direction 72b of the cutting element 18b, is disposed on a side of the cutter carrier element 16b that faces away from the cut-depth limiting element 20b.

The cutting-strand segment 10b additionally has two transverse securing elements 22b, 24b, disposed on the cutter carrier element 16b, which are provided to act in combination with a transverse securing region of the further cutter carrier element, when the cutter carrier element 16b has been coupled to the further cutter carrier element. The transverse securing elements 22b, 24b are each disposed in an edge region of the cutter carrier element 16b that delimits a connecting recess 50b of the cutter carrier element 16b. The transverse securing elements 22b, 24b in this case are realized so as to be integral with the cutter carrier element 16b. The transverse securing elements 22b, 24b are each integrally formed on to the cutter carrier element 16b, by means of a stamping process.

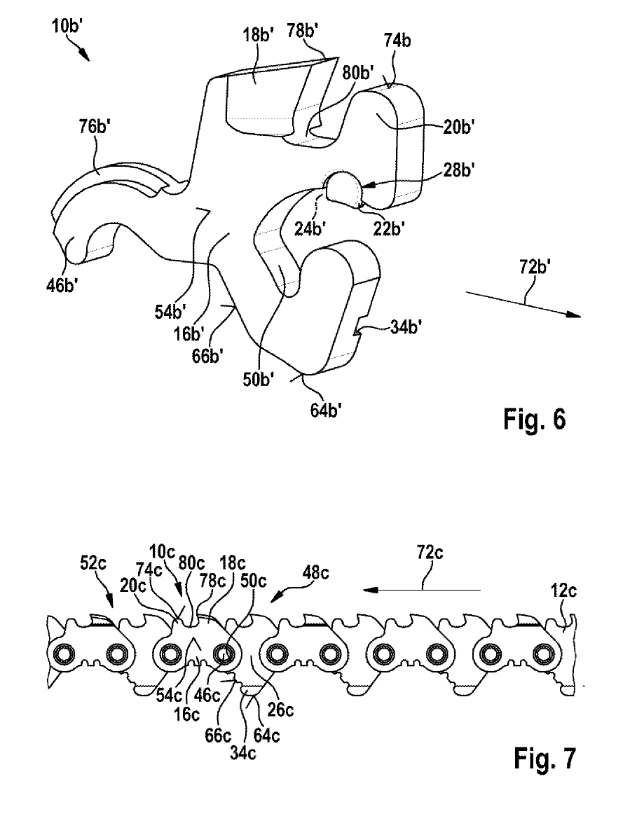

FIG. 6 shows a cutting strand segment 10b′ as an alternative realization of the cutting strand segment 10b from FIG. 5. The cutting strand segment 10b′ is of a design that is at least substantially similar to that of the cutting strand segment 10b from FIG. 3. The difference between the cutting strand segment 10b from FIG. 3 and the cutting strand segment 10b′ consists in a design of the cutting element 18b of the cutting strand segment 10b from FIG. 5 and that of the cutting element 18b′ of the cutting strand segment 10b′ from FIG. 6. The cutting element 18b′ of the cutting strand segment 10b from FIG. 6 has, along a cutting direction 72b′ of the cutting element 18b′, a varying offset, relative to an outer face 54b′ of a cutter carrier element 16b′ of the cutting strand segment 10b′. The cutting element 18b′ in this case is disposed on the cutter carrier element 16b′, inclined relative to the cutter carrier element 16b′, about two axes running at least substantially perpendicularly, relative to the outer face 54b′. The two at least substantially perpendicular axes in this case are preferably at least substantially parallel to the outer face 54b′ of the cutter carrier element 16b′ and/or to the cutting plane of the cutting element 18b′. In respect of further features of the cutting strand segment 10b′ from FIG. 4, reference may be made to the description of FIG. 5.

FIG. 7 shows an alternative cutting strand 12c. The cutting strand 12 comprises a multiplicity of cutting strand segments 10c, 48c, 52c, which each comprise at least one cutter carrier element 16c, at least one cutting element 18d disposed on the cutter carrier element 16c, and at least one cut-depth limiting element 20c, disposed on the cutter carrier element 16c, for limiting a maximum depth of cut of the cutting element 18c. The cutting strand 12c in this case has two types of cutting strand segment 10c, 48c, 52c. On the one hand, the cutting strand 12c has driving-member cutting strand segments and, on the other hand, has cutting-member cutting strand segments, which are disposed alternately in succession along a cutting direction 72c of the cutting elements 18c. For the purpose of connecting the cutting strand segments 10c, 48c, 52c, the cutting strand 12c comprises connecting elements 46c, realized separately from the cutting strand segments 10c, 48c, 52c. The connecting elements 46c are realized as connecting studs or connecting rivets. In this case, for the purpose of connecting the cutting strand segments 10c, 48c, 52c, the connecting elements 46c are pushed into connecting recesses 50c of the cutting strand segments 10c, 48c, 52c, and secured against falling out of the connecting recesses 50c by means of forming and/or welding a retaining region of the connecting elements 46c. In this case, all cutting strand segments 10c, 48c, 52c have a respective cut-depth limiting element 20c. It is also conceivable, however, for only cutting strand segments 10c, 48c, 52c to have cut-depth limiting elements 20c, which are realized as cutting members or as driving members. Further combinations of an arrangement of cut-depth limiting elements 20c on the cutting strand segments 10c, 48c, 52c are likewise conceivable. In respect of further features of the cutting strand segments 10c, 48c, 52c, reference may be made to the description of FIGS. 1 to 3.

1. A cutting strand segment for a cutting strand of a power-tool parting device, comprising;
at least one cutter carrier element that includes:
at least one cutting element disposed on the at least one cutter carrier element; and
at least one cut-depth limiting element, disposed on the at least one cutter carrier element and configured to limit a maximum depth of cut of the at least one cutting element, to a value that is less than 0.5 mm.

2. The cutting strand segment as claimed in claim 1, wherein the at least one cut-depth limiting element is configured to limit a maximum depth of cut of the at least one cutting element to a value that is less than 0.3 mm.

3. The cutting strand segment as claimed in claim 1, further comprising:
a further cutter carrier element; and
at least one transverse securing element, which is disposed on the at least one cutter carrier element and which is configured to secure the cutter carrier element, when in a mounted state, against a transverse movement relative to the further cutter carrier element.

4. The cutting strand segment as claimed in claim 3, wherein the at least one transverse securing element has at least one securing region that is at least substantially parallel to a cutting plane of the at least one cutting element.

5. The cutting strand segment as claimed in claim 1, the cutting strand segment having a maximum volume that is less than 20 mm³.

6. (canceled)

7. A cutting strand for a power-tool parting device, comprising:
at least one cutting strand segment that includes:
at least one cutter carrier element having:
at least one cutting element disposed on the at least one cutter carrier element; and
at least one cut-depth limiting element disposed on the at least one cutter carrier element and configured to limit a maximum depth of cut of the at least one cutting element to a value that is less than 0.5 mm.

8. A power-tool parting device comprising:
at least one cutting strand that includes:
at least one cutting strand segment that has:
at least one cutter carrier element with:
at least one cutting element disposed on the at least one cutter carrier element; and
at least one cut-depth limiting element disposed on the at least one cutter carrier element and configured to limit a maximum depth of cut of the at least one cutting element to a value that is less than 0.5 mm.

9. The power-tool parting device as claimed in claim 8, further comprising at least one guide unit;
wherein the at least one cutting strand segment further has at least one segment guide element, which is disposed on the at least one cutter carrier element and which is configured to limit a movement of the at least one cutting strand segment, when the at least one cutting strand is disposed on the guide unit, viewed in a direction away from the guide unit, at least along a direction that is at least substantially parallel to a cutting plane of the at least one cutting element.

10. The power tool parting device as claimed in claim 8, wherein the power tool parting device is configured to couple to a portable power tool in at least one of a form-fitting and force fitting manner via a coupling device.

11. The power tool parting device as claimed in claim 8, wherein the power tool parting device is included with a portable power tool in a power tool system.
